(19) United States
(12) Patent Application Publication
(10) Pub. No.: US 2025/0035765 A1
(43) Pub. Date: Jan. 30, 2025

(54) APPARATUS AND METHOD FOR PROXIMITY SENSING

(71) Applicant: Samsung Electronics Co., Ltd., Gyeonggi-do (KR)

(72) Inventors: Paboda Viduneth Ariyarathna BERUWAWELA PATHIRANAGE, San Diego, CA (US); Oren ELIEZER, San Diego, CA (US); Gennady FEYGIN, San Diego, CA (US); Wan Jong KIM, Tustin, CA (US); Pranav DAYAL, San Diego, CA (US); Bhupinder Singh Sachdev, San Diego, CA (US)

(21) Appl. No.: 18/767,412

(22) Filed: Jul. 9, 2024

Related U.S. Application Data
(60) Provisional application No. 63/513,605, filed on Jul. 14, 2023.
(60) Provisional application No. 63/513,742, filed on Jul. 14, 2023.

(51) Int. Cl. G01S 13/04; G01S 7/03

(52) U.S. Cl. CPC G01S 13/04; G01S 7/03

(57) ABSTRACT

A system and a method are disclosed for proximity detection using a phased antenna array including multiple antenna elements. A method includes transmitting, via a first antenna element and a second antenna element among the multiple antenna elements, a transmission signal; determining, for the first antenna element, a first power of a first injected signal and a second power of a first reflected signal corresponding to the transmission signal; determining, for the second antenna element, a third power of a second injected signal and a fourth power of a second reflected signal corresponding to the transmission signal; calculating, for the first antenna element, a first power metric based on at least one of the first power of the first injected signal or the second power of the first reflected signal; calculating, for the second antenna element, a second power metric based on at least one of the third power of the second injected signal or the fourth power of the second reflected signal; comparing the first power metric with a first threshold value; comparing the second power metric with a second threshold value; and determining whether an object is detected within a proximity range of the phased antenna array, based on the comparison of at least one of the first power metric with the first threshold value or the second power metric with the second threshold value.

### CROSS-REFERENCE TO RELATED APPLICATION

This application claims the priority benefit under 35 U.S.C. § 119 (c) of U.S. Provisional Application Nos. 63/513,605 and 63/513,742, which were both filed in the U.S. Patent and Trademark Office on Jul. 14, 2023, the disclosure of each of which is incorporated by reference in its entirety as if fully set forth herein.

### TECHNICAL FIELD

The disclosure generally relates to body proximity sensing and to wireless transmission which are combined in a joint communications and sensing system. More particularly, the subject matter disclosed herein relates to improvements to the use of multiple transmitting antenna paths of 5th generation (5G) phased arrays to reliably detect the presence of a nearby human body or object while relying only on the hardware that already exists for the wireless communications, thereby providing a cost effective solution.

### SUMMARY

Wireless communications in the mm-wave frequency range FR2 of the 5G cellular bands (above 24 GHz) utilize high gain antenna array beams intended to provide more directional transmission that would more effectively overcome propagation losses and minimize interference to other users. Consequently, nearby objects, such as a human body, that are present in the antenna beam can obstruct the beam and degrade the wireless communication link performance, and may also be exposed to an electromagnetic-field (EMF) power density (PD) level that exceeds the allowed limit set forth by regulatory bodies.

Regulations set by the Federal Communications Commission (FCC) and other governing bodies, such as the International Commission on Non-Ionizing Radiation Protection (ICNIRP), define limits on the amount of radiation that a user may be exposed to over a specific time period. This limit is referred to as a maximum permitted exposure (MPE) for 5G FR2 operations, and it is set to a maximum PD of 1 mW/cm² averaged over a duration of 4 seconds.

When a human body is in close proximity to an FR2 radio, the emissions that the human body is exposed to might exceed the MPE level, which would necessitate reduction in the transmitter's output power level and/or its duty cycle of operation. Such a situation may arise when a transmitting antenna or antenna array is directed towards or positioned near a human body, e.g., within 10 cm from a point of emission.

To ensure a wireless device's compliance with the PD limit in an environment where humans may be moving around it, it may be necessary for the wireless device to have the capability to detect the presence of a human body during its transmission and to periodically determine whether it must restrict its transmissions in power and/or duration.

Proximity detection may also help to maintain communication link performance by allowing transmissions to be switched to a different beam (i.e., angle switched) or by switching entirely to a different antenna array module co-located on a user equipment (UE) that does not have an object present in its beam.

Therefore, a mm-wave radio should have sufficient capability to detect the human body/blockage presence.

To address this need, proximity sensors based on light, infrared (IR), capacitive sensors, or image/camera sensors may be used to detect a human body/blockage presence. Additionally, frequency modulated continuous wave (FMCW)-based radar solutions (e.g., at a 60 GHz industrial, scientific, and medical (ISM) band) may be used. However, each of these attempted solutions requires dedicated hardware, or entails separate real-estate for radio frequency integrated circuit (RFIC) implementations, leading to increased size, weight, power consumption, and cost, in the final product.

Further, solutions based on FMCW radar have limitations on a minimum detectable range and challenges with a higher chirp bandwidth that would be required for resolving small distances.

Other methods based on various sensors also have issues like interference in extreme environments or scenarios in which sensor readings fall into indistinguishable ranges, which can lead to false positive/negative detections.

To overcome these issues, systems and methods are described herein, which use multiple transmitting antenna paths of FR2 phased arrays to reliably detect the presence of a human body or an object without dedicated or extra hardware beyond what is already used for regular FR2 mm-wave cellular operations.

These approaches improve on previous methods because they do not require dedicated or additional hardware to be used, thereby reducing size, weight, power consumption, and cost.

In an embodiment, a method is provided for proximity detection using a phased antenna array including multiple antenna elements. The method comprises transmitting, via a first antenna element and a second antenna element among the multiple antenna elements, a transmission signal; determining, for the first antenna element, a first power of a first injected signal and a second power of a first reflected signal corresponding to the transmission signal; determining, for the second antenna element, a third power of a second injected signal and a fourth power of a second reflected signal corresponding to the transmission signal; calculating, for the first antenna element, a first power metric based on at least one of the first power of the first injected signal or the second power of the first reflected signal; calculating, for the second antenna element, a second power metric based on at least one of the third power of the second injected signal or the fourth power of the second reflected signal; comparing the first power metric with a first threshold value; comparing the second power metric with a second threshold value; and determining whether an object is detected within a proximity range of the phased antenna array, based on the comparison of at least one of the first power metric with the first threshold value or the second power metric with the second threshold value.

In an embodiment, a system comprises an antenna array including multiple antenna elements; and a processor configured to transmit, via a first antenna element and a second antenna element among the multiple antenna elements, a transmission signal, determine, for the first antenna element, a first power of a first injected signal and a second power of a first reflected signal corresponding to the transmission signal, determine, for the second antenna element, a third power of a second injected signal and a fourth power of a second reflected signal corresponding to the transmission signal, calculate, for the first antenna element, a first power metric based on at least one of the first power of the first injected signal or the second power of the first reflected signal, calculate, for the second antenna element, a second power metric based on at least one of the third power of the second injected signal or the fourth power of the second reflected signal, compare the first power metric with a first threshold value, compare the second power metric with a second threshold value, and determine whether an object is detected within a proximity range of the phased antenna array, based on the comparison of at least one of the first power metric with the first threshold value or the second power metric with the second threshold value.

### BRIEF DESCRIPTION OF THE DRAWING

In the following section, the aspects of the subject matter disclosed herein will be described with reference to exemplary embodiments illustrated in the figures, in which:

FIG. 1 illustrates a multi-antenna-based proximity detection system according to an embodiment;

FIG. 2 illustrates a multi-antenna-based proximity detection operation according to an embodiment;

FIG. 3 illustrates an example of a combined signal yₙ(t) on a complex IQ plane, according to an embodiment.

FIG. 4 is a flow chart illustrating a method of proximity detection using a phased antenna array including multiple antenna elements, according to an embodiment;

FIG. 5 is a block diagram of an electronic device in a network environment, according to an embodiment; and

FIG. 6 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In accordance with an embodiment of the disclosure, multiple transmitting antenna paths of an FR2 phased array may be used to reliably detect the proximity of a human body or an object without the use of dedicated or additional hardware beyond what is already used for regular FR2 mm-wave cellular operations, thereby offering a zero-cost implementation of this feature.

A typical FR2 radio includes a phased array including more than one antenna element for increased directivity. In a phased array that is used for transmission, power from a transmitter is fed to the antenna elements through devices called phase shifters, controlled by a processor, which can alter the phase or signal delay electronically, thus steering the radiated beam to a desired direction. When used for reception, the phased array coherently combines power received from its multiple antenna elements with appropriate phase shifts so as to create directivity (increased reception gain) in a particular desired direction.

Generally, each transmit path includes one or more power detectors that can monitor a first power injected to an antenna element and a second power being reflected by the antenna element. The reflected signal (or the reverse signal) may be a sum of the reflected signal due to impedance mismatches (i.e., electrical reflection) and mutually coupled signals from other antenna elements in a free-space propagation scenario (i.e., without electromagnetic reflections).

During a transmission interval, if there is a human body present in the transmit beam, the electromagnetic signal reflected from the human body, which is picked up by the transmission antenna simultaneously (i.e., the antenna receives while transmitting), would be superimposed on top of the ambient reverse signal mentioned above, which may change the overall power-level detected by the reverse power-detector depending on the resultant vector sum of the electromagnetic reflected signal and the ambient reverse signal.

Due to inherently different active scattering-parameters at each antenna element in the phased array, the received power due to the ambient reverse power can be different in the detectors of each antenna path and the addition of the reflected signal from a human body can produce different power variations in each of the multiple antenna paths, and in accordance with an embodiment of the disclosure, can be exploited towards proximity detection. Accordingly, the present disclosure provides various techniques for detecting a human body based on power detector readings from the multiple antenna paths, while minimizing the probability of false detection (i.e., erroneously producing an alert corresponding to the close proximity of a human).

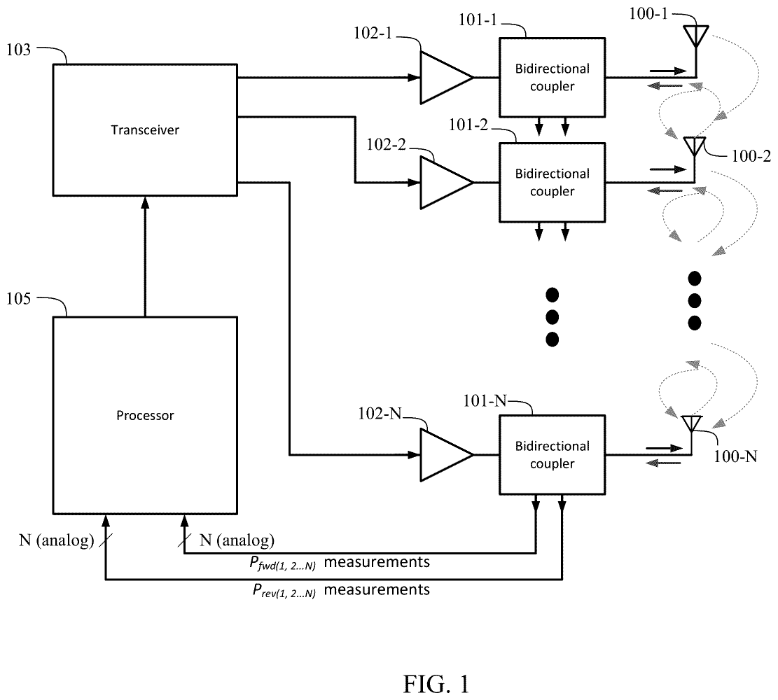

FIG. 1 illustrates a multi-antenna-based proximity detection system according to an embodiment. For example, the system may be a cellular phone, tablet, or any other device configured to communicate using radio frequency (RF) signals.

Referring to FIG. 1, the system includes an antenna array including antenna elements 100-1 to 100-N, bi-directional couplers 101-1 to 101-N respectively corresponding to each of the antenna elements 100-1 to 100-N, transmission power amplifiers 102-1 to 102-N respectively corresponding to each of the antenna elements 100-1 to 100-N, a transceiver 103, and a processor 105.

The processor 105 may be a central processing unit (CPU) of the system, a baseband processor included in a baseband modem, etc. The processor 105 may control the overall operations of the system.

The transceiver 103, which may include a transmitter and a receiver, may be a component typical to, and used for, engaging in radio communication between the system and another communicating entity.

The transceiver 103 and the processor 105 may be part of a common chipset or implemented in a combination of different chipsets or other implementation forms without deviating from the scope of the present disclosure.

Each of the transmission power amplifiers 102-1 to 102-N may be used to amplify signals for transmission via each of the antenna elements 100-1 to 100-N.

Each of the bi-directional couplers 101-1 to 101-N may be used to measure the power of signals injected and reflected through each of the corresponding antenna elements 100-1 to 100-N. These measurements (e.g., forward power measurements (P_{fird}) and reverse power measurements (Pᵣₑᵥ)) are then fed back for the processor 105 and may be used for object detection. The number of the bi-directional couplers 101-1 to 101-N and antenna elements 100-1 to 100-N, i.e., N, may vary depending on system design.

Although FIG. 1 illustrates an example of a system according to an embodiment, the system may also be implemented in other configurations without deviating from the scope of the present disclosure. That is, the system is not limited to the configuration illustrated in FIG. 1 and may include additional components, e.g., a memory, a power amplifier, a digital-to-analog-converter (DAC), an analog-to-digital-converter (ADC), e.g., to convert measurement received from the bi-directional couplers 101-1 to 101-N, etc., or fewer components.

During a transmission operation, a signal is provided from the transceiver 103, via the transmission power amplifiers 102-1 to 102-N, to antenna elements 100-1 to 100-N. The antenna elements 100-1 to 100-N receive the signal from the transceiver 103, and radiate the signal as radio waves. One of the ports of the bi-directional coupler (101-1 to 101-N) couples a small amount of the signal injected in to the antennas.

Generally, however, a portion of the transmitted signal is reflected back and the amount of signal reflected back is tracked through another port of the bi-directional coupler. The portion of the transmitted signal that is reflected back may be a function of the antenna load.

In addition to the reflected signal that results from impedance mismatch, in an active phased-array, the reverse signal/power becomes a function of the power being transmitted by the other antennas as well, due to the inevitable mutual coupling between the antenna elements 100-1 to 100-N. These physical phenomena set the ambient signal power-level seen at the reverse port of the directional coupler under free space radiation of the device, i.e., in the absence of an object in its proximity.

Further, the reverse signal seen by the directional couplers 101-1 to 101-N may also be affected by a signal reflection from a nearby object, e.g., a human body, when present during operation of the system. A portion of the transmitted signal that is reflected from that body or object (e.g., the user's hand, head, etc.) will be picked by the system's antennas and will be added to the ambient reverse signal (already present due to impedance mismatch and the mutual coupling) and this may noticeably change the measured power-level seen at the reverse-signal output from the coupler, depending on how these multiple on-frequency contributors add up as vectors (i.e., based on their relative magnitudes and phases).

More specifically, a bi-directional coupler couples a small portion of both forward and reverse signals going through it (thus, the name bi-directional) allowing to keep track of the power injected to the antenna and the power reflected back from the antenna. Since any reflection from an object picked by the antenna will also appear as a reverse direction signal, it will be superimposed on the aforementioned ambient reverse signal, and the combined signal will show up in the reverse port of the coupler.

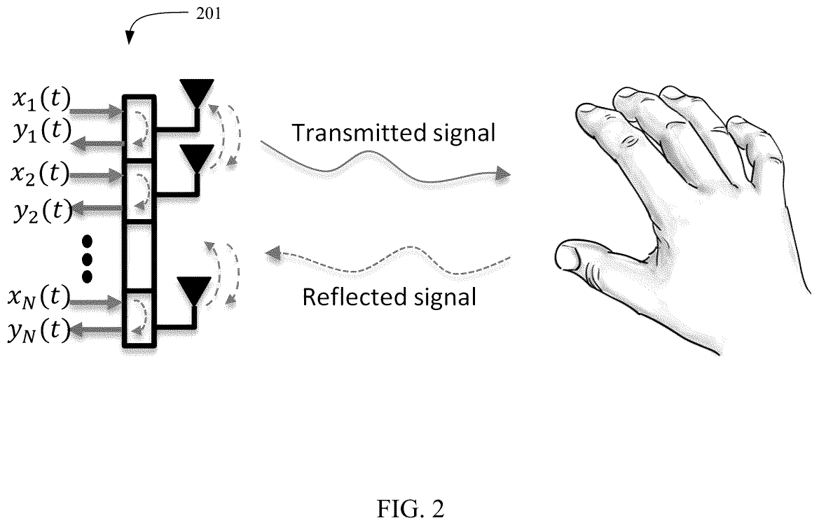

FIG. 2 illustrates a multi-antenna-based proximity detection operation according to an embodiment.

Referring to FIG. 2, a user's hand 210 is present during operation of a system 201, and a portion of the signals transmitted from the system 201 are reflected off the user's hand 210, and fed back into the system 201, as the system's antennas may transmit and receive simultaneously.

In FIG. 2, xₙ(t) represents a signal going into an n^{th} antenna and yₙ (t) represents a total reverse signal captured from forward and reverse ports of a bi-directional coupler, respectively at the n^{th} antenna path and can be represented as given in Equation (1) below.

$${y}_{n} ( t ) = {\overline{S}}_{nn} \cdot {x}_{n} ( t ) + {r}_{n} ( t ) \qquad ( 1 )$$

In Equation (1), rₙ(t) is a reflected signal picked up by the n^{th} antenna after being scattered by a human body (e.g., the user's hand 210) or an object, and S̅ₙₙ is an active S-parameter of the antenna array. Active S-parameters are used in an array environment, while S-parameters are used for single antennas. The active S-parameter of an antenna within an array is its S-parameter when the other antennas are excited. S̅ₙₙ can be defined as shown in Equation (2) below.

$${\overline{S}}_{nn} = \frac{{\sum }_{m = 1}^{N} ( {S}_{nm} {x}_{m} ( t ) )}{{x}_{n} ( t )} \qquad ( 2 )$$

In Equation (2), Sₙₘ represents regular N-port S-parameters, and xₘ(t) represents the signal injected into an m^{th} antenna.

The active S-parameter S̅ₙₙ in Equation (2) incorporates the effect of the reflection due to the impedance mismatch at the n^{th} antenna port as well as the effect of mutual coupling from the active transmission of other antennas. Generally, the Sₙₙ term in Equation (2) dominates over the mutual coupling terms in the summation.

In accordance with an embodiment of the disclosure, the reverse power-level of all or a subset of the antennas from the phased array may be fused for improved detection of near-proximity objects.

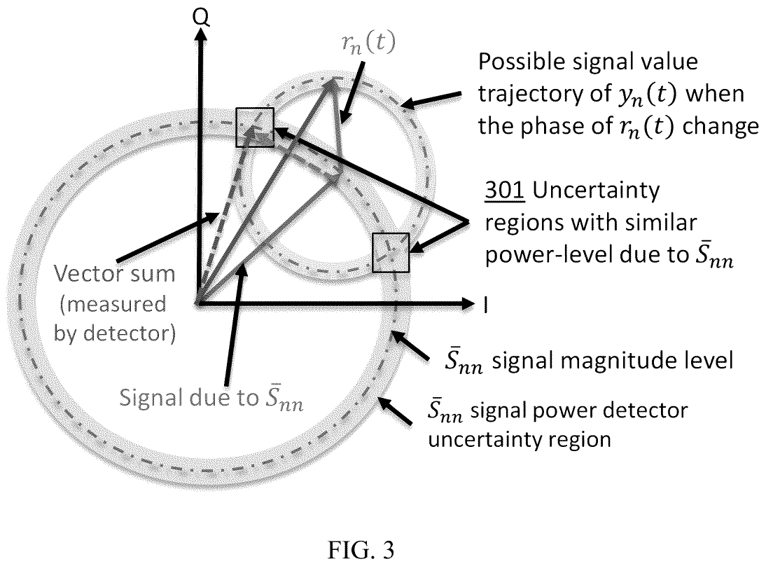

FIG. 3 illustrates an example of a combined signal yₙ (t) on a complex IQ plane, according to an embodiment.

Referring to FIG. 3, the signal yₙ (t) is illustrated graphically, when |S̅ₘₙxₙ(t)|>>|rₙ(t)| (i.e., when the ambient reverse power is much stronger than the reflected signal from an object, such that the two cannot cancel each other).

As illustrated in FIG. 3, when the reflected signal from the nearby object is present, the signal of interest yₙ (t) will have different signal/power levels than in a “no-object” present scenario, except for when the yₙ (t) signal level falls into two uncertainty regions 301. The change in the power level seen in a coupler's reverse port due to the presence of the object allows for a detection algorithm to identify the presence of a nearby human body/object.

The uncertainty regions 301 correspond to two unique distances in each half-wavelength (of the carrier frequency) increment of distance (in a periodic manner) from the transmitting array, as long as 2|S̅ₘₙxₙ(t)|>|rₙ(t)|.

When |rₙ(t)|>2|S̅ₘₙxₙ(t)|, then such uncertainty regions will not occur, which will not result in any ambiguity for detection.

When 2|S̅ₘₙxₙ(t)|>|rₙ(t)|, relying on one antenna path, for which these uncertainty regions are experienced when the object is at specific distances, may lead to possible misdetections, which motivates the use of additional inputs for an algorithm to decide whenever signal levels of yₙ (t) falls in the “uncertainty areas.” Therefore, in accordance with an embodiment of the disclosure, yₙ (t) signals from multiple antennas are used, wherein the uncertainty regions for each antenna may fall at a different instance (i.e., when the object is placed at a different distance from the array).

Due to antenna array geometry and variation of output impedance levels of each power-amplifier driving each antenna port, S̅ₘₙ complex values for different antenna indices n ∈[1, N] will have different magnitude and phase values. Therefore, it is probabilistically unlikely all uncertainty points in every antenna in the array will occur for the same distance from the point of transmission. Thus, probing into all or multiple antenna elements and using them with a detection algorithm allows for improved detection while avoiding the uncertainty regions with respect to ambient reverse power levels, which may occur in the separate antenna paths.

To facilitate calibration and dealing with multiple different radiation power-levels, in accordance with an embodiment of the disclosure, a detection algorithm is provided to work on power ratio levels qₙ(t) at each path, as defined in Equation (3) below.

$${q}_{n} ( t ) = \frac{{\vert {x}_{n} ( t ) \vert}^{2}}{{\vert {y}_{n} ( t ) \vert}^{2}} \qquad ( 3 )$$

The proximity detection methodology includes a calibration phase during which threshold levels are determined for the later detection.

Table 1 shows an algorithm for a calibration step for use with a multi-antenna detection scheme, according to an embodiment. That is, Table 1 shows a simplified calibration procedure for each frequency f.

```
TABLE 1
Input: [|x₁(t)|², |x₂(t)|², ... , |x_{N}(t)|²], [|y₁(t)|², [y₂(t)|², ... , |y_{N}(t)|²]
Constants: Tₛ (sampling time), K (number of samples used for calibration)
Output: μ_{q,f} = [ [symbol] , q̅₂, ... , q̅_{N}], σ_{q,f} = [σ_{q}_{₁}, σ_{q}_{₂}, ... , σ_{q}_{_{N}}]
for each time step k, from 1 to K:
  for each antenna index n 1 to N:
    ${q}_{n} [ k ] = \frac{{\vert {x}_{n} ( t = {kT}_{s} ) \vert}^{2}}{{\vert {y}_{n} ( t = {kT}_{s} ) \vert}^{2}}$
for each antenna index n 1 to N:
    q̅ₙ = mean {qₙ}
    μ_{q,f} [n] = q̅ₙ
    ${σ}_{n , f} [ n ] = \sqrt{mean \{ {( {q}_{n} - {\overline{q}}_{n} )}^{2} \}}$
Return μ_{q,f}, σ_{q,f}
```

The calibration routine in the algorithm of Table 1 determines the average and the standard deviation of the reference-levels associated for the power ratio for a given frequency of operation. The standard deviation may be attributed to fluctuations in the measurements of the reference-levels originating from sources such as natural additive noise and quantization noise experienced in the digitization of the readings from the power detectors.

The computed threshold values from Table 1 can be then used in an algorithm for a real-time detection procedure as shown in Table 2, according to an embodiment, wherein logical operation OR is used to determine whether at least in one of the N antennas the power ratio has exceeded the threshold set for it based on the calibration step. That is, Table 2 shows a detection procedure for a given carrier frequency of operation f.

```
TABLE 2
Input: [|x₁(t)|², |x₂(t)|², ... , |x_{N}(t)|²], [|y₁(t)|², [y₂(t)|², ... , |y_{N}(t)|²], μ_{q,f}, σ_{q,f}
Constants: Tₛ (sampling time)
Output: detection_state
for each time step k (from start to end of transmission interval):
  for each antenna index n 1 to N:
  ${q}_{n} [ k ] = \frac{{\vert {x}_{n} ( t = {kT}_{s} ) \vert}^{2}}{{\vert {y}_{n} ( t = {kT}_{s} ) \vert}^{2}}$
  if |q₁[k] − μ_{q,f}[1]| > 3σ_{q,f}[1] OR |q₂[k] − μ_{q,f}[2] > 3σ_{g,f}[2] OR ... OR
        |q_{N}[k] − μ_{q,f}[N]| > 3σ_{q,f}[N]
    detection_state = 1
  else:
    detection_state = 0
Return detection_state
```

As shown in Table 2 above, an estimate of the forward over reverse power ratio is compared against the established thresholds μ_{q,f} and σ_{q,f}. Any power ratio measured outside the threshold region in any of the antenna paths may be considered a detection of an object.

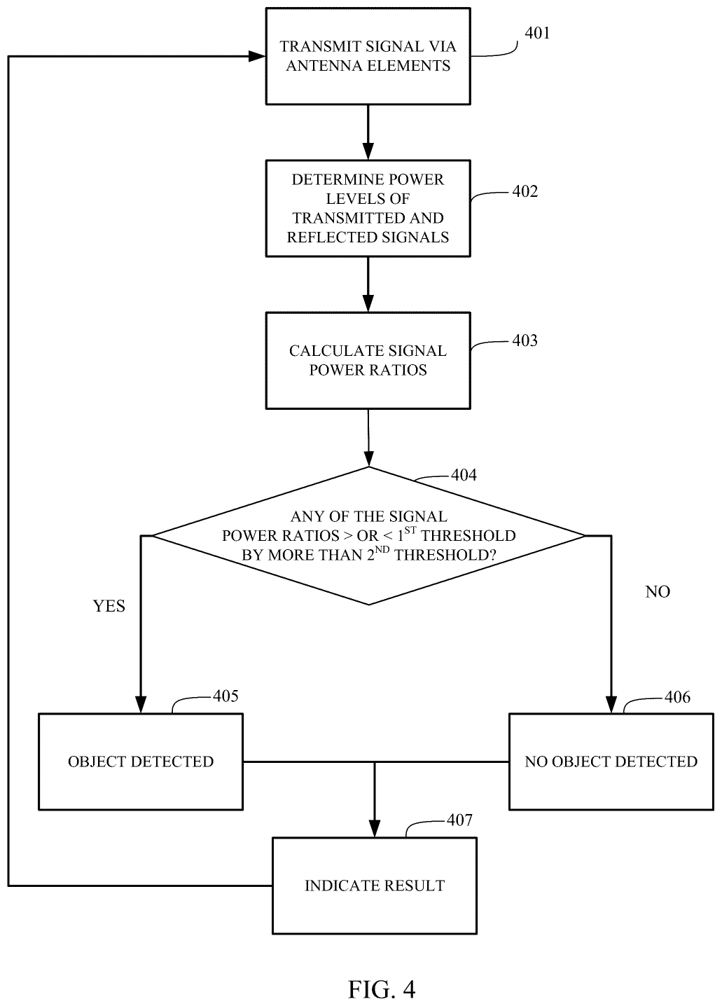

FIG. 4 is a flow chart illustrating a method of proximity detection using a phased antenna array including multiple antenna elements, according to an embodiment.

Referring to FIG. 4, in step 401, a transmission signal is transmitted from each of at least two of the multiple antenna elements. For example, as illustrated in FIG. 1, the processor 105 controls the transceiver 103 to transmit a signal through the antenna elements 100-1 to 100-N. As described above, all or a subset of the antennas from the phased array may be fused for improved detection of near-proximity objects.

In step 402, the power levels of the signals injected to the antenna elements are determined, along with the power levels of the reflected signals corresponding to the sum of the active S-parameters and the reflection from an object. That is, xₙ (t) and yₙ (t) are determined as described above with reference to Equations (1) and (2). For example, as illustrated in FIG. 1, the bi-directional couplers 101-1 to 101-N may be used to measure the power of forward and reverse signals at each of the corresponding antenna paths 100-1 to 100-N, where a reverse signal may be a resultant of the ambient active S-parameter-based reflections as well as any reflected signal from an object, e.g., a human body, which is present during operation of the system.

As described above, in an active phased-array, a portion of a transmitted signal that is reflected from a nearby object (e.g., the user's hand, head, etc.) will be picked by the system's antennas and will be added to the ambient reverse signal (already present due to impedance mismatch and the mutual coupling) and this may change the overall reverse power-level seen at the reverse-signal output from a coupler at that instance, allowing it to be distinguishable from what was measured before the object was present.

In step 403, power metrics, e.g., power ratios, are calculated for the antenna elements based on the determined power of the signals injected to the antenna elements (i.e., the forward power), and the determined power of the reflected signals corresponding to the injected signals (i.e., the reverse power), e.g., using Equation (3) above.

In step 404, for each of the calculated signal power ratios, it is determined whether it is greater or less than a first threshold value by at least a second threshold value, e.g., as illustrated in Table 2.

As shown in Table 1 above, the first threshold value may be a mean signal power ratio among all the calculated signal power ratios, and the second threshold value may be set to some multiple of the standard deviation of the calculated signal power ratios when no object is present during operation. The lower the multiple, the more sensitive the detection will be, while also increasing the probability of a false detection, thereby representing a tradeoff in settings its value.

In the example embodiment of Table 2, this coefficient is set to 3, for which the probability of false detection is known to be about 0.3% (for Gaussian distribution). Therefore, for a system with N antennas the false probability would be on the order of N·0.3%.

In step 405, in response to determining that a calculated signal power ratio is greater or less than a first threshold value by at least a second threshold value in any of the considered antenna elements, it is determined that an object is detected nearby.

In step 406, in response to determining that a calculated signal power ratio is not greater than a first threshold value by at least a second threshold value in any of the considered antenna elements, it is determined that no object is detected.

After step 405 or 406, the result is indicated to an appropriate device or module for appropriate handling in step 407. For example, for a device such as a 5G mobile handset, after step 405, the indication in step 407 may be useful for determining a possible need to reduce the transmission power so as to avoid violating the regulatory exposure limits. Similarly, after step 406, the indication in step 407 may be useful in determining that the transmission power and duty cycle may remain unrestricted, thereby avoiding possible compromises in the uplink throughput/range.

When determining that an object is detected nearby the antenna array, then the transmission power of the device, and/or its duty cycle, may be reduced accordingly.

After step 407, the method returns to step 401 to repeat the process.

Although the embodiment in FIG. 4 is described above using signal power ratios in steps 403 to 406, the disclosure is not limited thereto. That is, instead of using signal power ratios, different power metrics may be calculated based on the power levels of the signals injected to the antenna elements, along with the power levels of the reflected signals corresponding to the sum of the active S-parameters and the reflection from an object. For example, similar determinations may be based upon measurements of reverse power, without “normalizing” them to the forward power, or similar determinations may be based upon measurements of reverse power, and then considering forward power separately and combining with the reverse power measurements.

When an object is particularly close to the antennas (e.g., when a hand is gripping the mobile device in the location where the antennas are placed, or when placing a handset against the car/head), the impact on the effective impedances of the antennas may be considerable enough for the measurements of the forward power fed to them to be noticeably affected. Therefore, in accordance with an embodiment, a detection metric may include utilizing a threshold on the amount of change in the forward power measurements that would trigger a proximity-detection event.

Reverse power measurements, on the other hand, are generally more sensitive to changes in the reflected power that may result from the presence of an object at a greater distance, where it does not considerably affect the antennas impedance and hence may not be detected in the forward power measurements. However, the measurements of the reverse power may also be more prone to environmental changes, including temperature. Therefore, according to an embodiment, a more accurate calibration and compensation process may be utilized, wherein the reverse power is determined in the absence of any objects in proximity (e.g., factory calibration), and this reference measurement may then be compensated for environmental conditions, such as temperature and other changes, to allow for greater sensitivity in detecting changes caused by an object that is being detected. In the absence of such compensation/adaptation, the threshold for detection may be set higher, so as not to be triggered by natural variations in the reverse power, e.g., caused by temperature/environmental changes, thereby sacrificing sensitivity to changes in reverse power that are caused by objects of interest that would ideally be detected.

According to an embodiment, an example of a metric M that considers only the measurements of forward power, where a detection decision is not based on ratios of powers (i.e., does not consider measurements of reverse power), is given in Equation (4) below. In Equation (4), Pi (n), i=1 . . . . N represent levels of forward power that were measured historically, at instance n, in N≥1 TX paths (either during a calibration instance, or just prior to the current instance) and Pi (k), i=1 . . . . N represent the levels of forward power that are measured currently, at instance k>n.

$$M = {\sum }_{i = 1}^{N} {( {P}_{i} ( k ) - {P}_{i} ( n ) )}^{2} \qquad ( 4 )$$

As can be seen in Equation (4), the current measurements of forward power are compared only against their historical values, without considering measurements of reverse power and without considering the direction of change (whether increase or decrease), although it is likely that a scenario of gripping a handset, or holding it within very close proximity to the head/body, will result in the reduction of forward power due to the likely degradation in impedance matching of the antenna to the transmitters' outputs. Furthermore, this example metric shows a comparison of measurements from only one specific instance k against those of a refence instance n.

More generally, a metric may consider multiple consecutive measurement instances k, k+1 . . . k+L, which may span a total duration that would still be considered to correspond well with the possible rate of human movements and with a required response rate of the decision mechanism. The comparison involving the multiple instances may include averaging of the results or the identification of the most impactful among them, i.e., a maximum difference detected between a current instance and a reference instance. Here, M represents a dynamic impact of an object being detected, i.e., changes caused over time, and this impact may be compared against a threshold that is set based on empirical data, such that exceeding it would be considered to have been caused by an approaching human body, and may trigger a reduction in a mobile device's effective isotropic radiated power (EIRP), if necessary. For example, a reduction in a mobile device's EIRP would not be necessary if it already happens to be relatively low due to the use of a relatively low transmission power and/or a low duty cycle of transmission.

In accordance with another embodiment, a metric may be used that represents a combination of both ‘static’ and ‘dynamic’ impacts of an object being detected. The ‘static’ impact may be determined based only on a comparison against data obtained in calibration, i.e., reference measurements that are obtained in the absence of objects, and the ‘dynamic’ impact may be based only on measurements that are taken during normal operation, i.e., a comparison of current measurements against recent historical ones.

The combination of these two types of impacts may be performed with weighting that prefers one over the other based on reliability that is established empirically. Equation (5) below shows a linear combination of metrics that are determined through static and dynamic comparisons, where the weighting factor, a dynamic, determines a relative influence that each of these two contributors would have in the overall ‘impact’ calculation.

$${M}_{total} = {M}_{static} + {α}_{dynamic} \cdot {M}_{dynamic} \qquad ( 5 )$$

Additional considerations may also arise due to practical system limitations, e.g., the inability to measure forward and reverse power for a particular antenna at the same instance, and since the signal being measured may vary over time, this may introduce error and uncertainty. To address this type of problem, in accordance with an embodiment, the system may measure a reflected power detected on one antenna and a forward power on another antenna, which the system may be able to perform simultaneously, and then determine the power ratio based on these measurements, despite originating from different antennas. This method relies on the high correlation between the forward power measurements of the multiple antennas since they are fed with the same signal as the multiple antennas serve in a phased-array.

Additional functions involving reflected and forward power measurements from the multiple antennas may also prove advantageous, particularly when considering system limitations, including calibration and compensation implementation constraints, and should be considered within the scope of the invention.

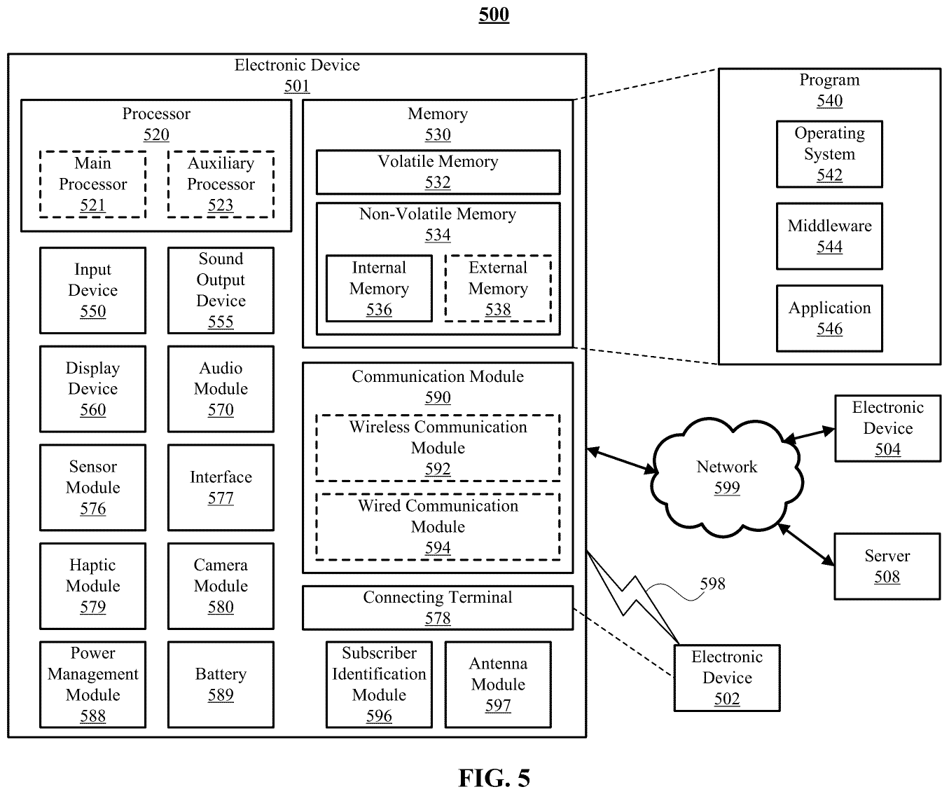

FIG. 5 is a block diagram of an electronic device in a network environment 500, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520, e.g., the processor 105 as illustrated in FIG. 1, may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a CPU or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). For example, the antenna module 597 may include the antenna elements 100-1 to 100-N as illustrated in FIG. 1. The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

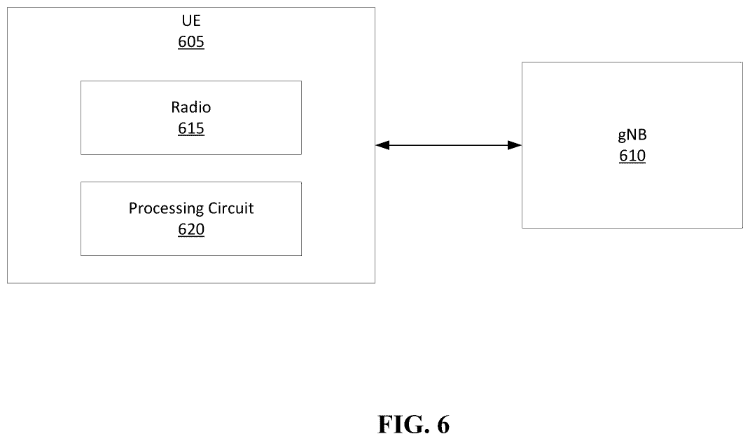

FIG. 6 shows a system including a UE 605 and a gNB 610, in communication with each other. The UE may include a radio 615 and a processing circuit (or a means for processing) 620, which may perform various methods disclosed herein, e.g., the method illustrated in FIG. 4. For example, the processing circuit 620 may receive, via the radio 615, transmissions from the network node (gNB) 610, and the processing circuit 620 may transmit, via the radio 615, signals to the gNB 610.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

In accordance with the above-described embodiments, the same hardware as used for mm-wave communications may be used to provide a multi-antenna-based detection scheme that provides improved reliable detection over a few centimeters. Further, reliable binary detection of an object/human body in a vicinity of the mm-wave module is provided. For example, detector signals from multiple antennas in a mm-wave phased array are used and a detection algorithm fuses multi-antenna inputs to provide improved detection reliability.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of proximity detection using a phased antenna array including multiple antenna elements, the method comprising:
transmitting, via a first antenna element and a second antenna element among the multiple antenna elements, a transmission signal;
determining, for the first antenna element, a first power of a first injected signal and a second power of a first reflected signal corresponding to the transmission signal;
determining, for the second antenna element, a third power of a second injected signal and a fourth power of a second reflected signal corresponding to the transmission signal;
calculating, for the first antenna element, a first power metric based on at least one of the first power of the first injected signal or the second power of the first reflected signal;
calculating, for the second antenna element, a second power metric based on at least one of the third power of the second injected signal or the fourth power of the second reflected signal;
comparing the first power metric with a first threshold value;
comparing the second power metric with a second threshold value; and
determining whether an object is detected within a proximity range of the phased antenna array, based on the comparison of at least one of the first power metric with the first threshold value or the second power metric with the second threshold value.

2. The method claim 1, wherein the first power metric includes a first power ratio based on the first power of the first injected signal and the second power of the first reflected signal.

3. The method of claim 2, wherein determining whether the object is detected within the proximity range of the phased antenna array comprises determining that the object is detected within the proximity range of the phased antenna array, in response to the first power ratio being greater or less than the first threshold value by at least a third threshold value.

4. The method of claim 3, wherein the first threshold value and the third threshold value are based on statistics of first power ratio values previously obtained during operations in which no object is present.

5. The method of claim 4, further comprising calibrating the statistics of the first power ratio values previously obtained during operations in which no object is present based on environmental conditions.

6. The method of claim 4, further comprising calculating the first threshold value as a mean power ratio among the first power ratios previously obtained during the operations in which no object is present.

7. The method of claim 3, further comprising calculating the third threshold value as a standard deviation of the first power ratios previously obtained during the operations in which no object is present.

8. The method claim 1, wherein the second power metric includes a second power ratio based on the third power of the second injected signal and the fourth power of the second reflected signal.

9. The method of claim 8, wherein determining whether the object is detected within the proximity range of the phased antenna array comprises determining that the object is detected within the proximity range of the phased antenna array, in response to the second power ratio being greater or less than the second threshold value by at least a fourth threshold value.

10. The method of claim 9, wherein the second threshold value and the fourth threshold value are based on statistics of second power ratio values previously obtained during operations in which no object is present.

11. The method of claim 10, further comprising calculating the second threshold value as a mean power ratio among the second power ratios previously obtained during the operations in which no object is present.

12. The method of claim 9, further comprising calculating the fourth threshold value as a standard deviation of the second power ratios previously obtained during the operations in which no object is present.

13. The method of claim 1, wherein the transmission signal includes a 5G frequency range 2 (FR2) millimeter-wave transmit signal.

14. The method claim 1, wherein the first power metric includes a first power ratio based on the first power of the first injected signal and the fourth power of the second reflected signal.

15. The method of claim 14, wherein determining whether the object is detected within the proximity range of the phased antenna array comprises determining that the object is detected within the proximity range of the phased antenna array, in response to the first power ratio being greater or less than the first threshold value by at least a third threshold value.

16. The method of claim 15, wherein the first threshold value and the third threshold value are based on statistics of first power ratio values previously obtained during operations in which no object is present.

17. The method claim 1, wherein the second power metric includes a second power ratio based on the third power of the second injected signal and the second power of the first reflected signal.

18. The method of claim 17, wherein determining whether the object is detected within the proximity range of the phased antenna array comprises determining that the object is detected within the proximity range of the phased antenna array, in response to the second power ratio being greater or less than the second threshold value by at least a fourth threshold value.

19. The method of claim 18, wherein the second threshold value and the fourth threshold value are based on statistics of second power ratio values previously obtained during operations in which no object is present.

20. A system, comprising:
an antenna array including multiple antenna elements; and
a processor configured to:
transmit, via a first antenna element and a second antenna element among the multiple antenna elements, a transmission signal,
determine, for the first antenna element, a first power of a first injected signal and a second power of a first reflected signal corresponding to the transmission signal,
determine, for the second antenna element, a third power of a second injected signal and a fourth power of a second reflected signal corresponding to the transmission signal,
calculate, for the first antenna element, a first power metric based on at least one of the first power of the first injected signal or the second power of the first reflected signal,
calculate, for the second antenna element, a second power metric based on at least one of the third power of the second injected signal or the fourth power of the second reflected signal,
compare the first power metric with a first threshold value,
compare the second power metric with a second threshold value, and
determine whether an object is detected within a proximity range of the phased antenna array, based on the comparison of at least one of the first power metric with the first threshold value or the second power metric with the second threshold value.
